(19) United States
(12) Patent Application Publication
(10) Pub. No.: US 2005/0180330 A1
(43) Pub. Date: Aug. 18, 2005

(54) METHOD OF ANIMATING TRANSITIONS AND STABILIZING NODE MOTION DURING DYNAMIC GRAPH NAVIGATION

(75) Inventor: Alexander Shapiro, Livingston, NJ (US)

Correspondence Address: Alexander Shapiro, 21 Hearthstone Terr, Livingston, NJ, 07039, US

(73) Assignee: TOUCHGRAPH LLC, Livingston, NJ (US)

(21) Appl. No.: 10/906,396

(22) Filed: Feb. 17, 2005

Related U.S. Application Data
(60) Provisional application No. 60/544,928, filed on Feb. 17, 2004.

(51) Int. Cl. H04L 1/00

(52) U.S. Cl. 370/241

(57) ABSTRACT

In a system and method for arranging a graph according to a Force-Directed Layout algorithm, a node-set transition in the graph may be animated by iteratively reducing or increasing an impact value of one node on another node, and a velocity of a node may be reduced in proportion the to the degree of its non-directional movement.

### FIELD OF THE INVENTION

The present invention relates to a computerized system for drawing graphs. More particularly, it relates to an interactive graph-drawing system with dynamic layout and navigation.

### BACKGROUND OF THE INVENTION

In the field of computer-aided visualization systems and techniques, some of the most frequently-used and useful applications created for visualization purposes are graph visualization/diagramming applications. Some of the most frequently-used and useful applications created for visualization purposes are graph visualization/diagramming applications. These have many functions, among them creating flowcharts and UML diagrams, displaying electronic circuit diagrams, showing connections between hardware devices in a communication network, and visually diagramming connections between modules in a computer program. Many algorithms have been developed to lay out the above structures, which are traditionally represented as a set of boxes or nodes, connected by connecting lines, referred to herein as edges.

It is desirable to display a diagram in a readable manner, for example by displaying the diagram in a manner that allows a user to see labels on the nodes and to trace the edges to see how the nodes are connected together. It is desirable to display the nodes so that the user may read the labels on all of the nodes. Therefore, graphs are conventionally displayed in a two-dimensional plane, so that one node is not obscured by another that would otherwise be in front of it in a third dimension. Highly connected graphs represented in a plane may cause edge crossings. Because multiple edge crossings make a graph difficult to read, readable graphs displayed in two dimensions must either have a small number of nodes, or have a low number of interconnections between them.

Conventional diagramming tools are designed to let the user create readable and aesthetically pleasing diagrams. Because of said limitations of creating readable graphs, these diagrams mostly contain fewer than 1000 nodes, and usually fewer than 100. There is also a class of graph visualization tools that are meant to show connections between huge numbers of nodes. Usually, the diagrams created by these tools are not readable at a node level, and present something that looks like a cloud, where regions of density and color coding indicate variation within the data represented.

For both conventional diagramming tools and large scale graph visualization tools, the end goal has traditionally been to generate a single diagram, or perhaps a series of diagrams. These tools are not meant for browsing through the data, but are attempts to come up with a single ultimate representation, or a series of ultimate representations, of the data.

The advent of the internet and of huge publicly-accessible databases has made available large networks of data which are ideal beneficiaries for visual interpretation. Examples of such networks are networks of websites, networks of scientific documents connected together by citation, networks of books or other products connected by purchasing patterns, biological networks of proteins, and “social” networks of members of online communities,

Because of the limitations on the number of nodes that can be displayed at once in a coherent diagram, large networks such as those discussed above must be displayed in part only. However, a given user will most likely desire to see more then a single diagram of a part of the network, and will wish to explore the whole network, for instance to browse a network of books to find other areas of interest.

Dynamic graph navigation solves this problem by allowing the user to switch between subsets of the network while making the transitions easy to follow. In order to maintain readability and coherence, nodes and edges must be repositioned as some nodes are added to the graph and/or others are removed. To do so, tools for browsing such networks conventionally implement an algorithm that simulates the graph as a physical system, treating the nodes as physical components that exert forces on each other, e.g., treating each node as a particle that repels other nodes while treating edges between nodes as attractors. Through this algorithm, nodes generally arrange themselves far enough apart that their labels can be read and individual nodes can be discerned.

However, such algorithms have several major flaws that hinder their ability to arrange nodes during dynamic navigation. These algorithms are often confused by highly connected graphs where large numbers of node and edge forces pull nodes in different directions, and cause the nodes to move in a fashion that is haphazard and difficult for a user to follow. Nodes often meander around the screen for long periods of time before stopping and end up in non-optimal locations. Existing algorithms arrange the nodes by moving them either too chaotically to follow or too slowly for comfortable use. These algorithms were initially designed for use in creating static diagrams, a process which does not require the users to be able to follow the motion of the nodes during layout, and can permit nodes to move quickly and chaotically prior to assuming their final locations. The algorithms were later modified to slow down node motion by applying additional friction forces, but this causes some nodes to move too slowly, increases the time that the layout takes to stabilize, and causes nodes to stop before they reach their optimal positions.

The addition and removal of nodes presents another problem. Current algorithms do not take special measures when nodes are added and removed, which creates unbalanced forces and causes the graph to be moved in a jarring way. The addition and removal of nodes thus causes a flurry of motion, making the process confusing and difficult to follow. When the visible set of nodes is changed, as frequently happens during dynamic navigation, the user cannot immediately see what has changed, what is new or has gone missing, and how the on-screen relationships have been modified. Accordingly, there is a need in the art for a system and method that provides a transitional animation that would allow a user to visually discern the nature of a transition in a comprehensible manner.

### SUMMARY OF THE INVENTION

The deficiencies of known layout algorithms are substantially overcome by the present invention which relates to animating transitions between graph states. The methods provided by the invention provide a visually coherent way to animate the transition between two sets of nodes in a graph by making node movements easy for a user to follow, and further provide a way to reduce non-directional and erratic node motion to improve and speed up the layout process.

As referred to herein, a Force-Directed Layout Algorithm (FD Layout algorithm) is defined as an algorithm that simulates a physical system to position nodes of a graph. The FD Layout algorithm may operate on a graph where nodes have vector attributes, referred to herein as Position vectors or position, and may iteratively adjust values of the Position vectors. According to example embodiments of the present invention, the user may easily browse through a network displayed by a system using a FD Layout algorithm. The user may browse the displayed network, for example, by viewing only a portion of the network at a time and focusing on the interconnections of that portion while also being able to move to other portions simply and rapidly.

Ghosting

An example embodiment of the present invention introduces a technique, referred to herein as Ghosting, for animating the addition and removal of nodes to and from the graph. Nodes are constantly added and removed during dynamic navigation, for example when the user navigates between local parts of a large network, and/or in response to changing filter settings. As new nodes are added, the embodiment of the Ghosting technique uses a modified FD Layout algorithm to animate their introduction to the graph by gradually fading in their effects on other nodes. For example, new nodes start out having no effect on nodes already in the graph, like ghosts, and then gradually fade into full existence by exerting more and more force on other nodes until they are fully faded in and have the same effects as all other nodes. Similarly, nodes that are removed from the graph are faded out, and their effects on nodes that remain are gradually diminished until they produce no effect and disappear.

In one example embodiment, the fading in and out of nodes and their effect on other nodes may be accompanied by a change of node color and transparency. The color change makes it easier to follow which nodes are being added and removed, and the change in transparency makes their addition and removal less sudden.

In an example embodiment of the present invention, the coordinates of nodes that are removed may be retained in memory. When nodes that had been removed are once again added to the graph, they may be placed in their previous locations, which may cause them to be arranged in a familiar configuration. This makes it easier for the user to follow transitions between node sets, and gives a better sense of the overall network structure.

The Ghosting technique may enable the FD Layout algorithm to move the graph towards a new stable position in an optimal and visually coherent manner, even while multiple nodes are simultaneously added and taken away. The user's task of tracking nodes that have disappeared and reappeared is made simpler by their gradual introduction or removal.

Noise Damper

An example embodiment of the present invention introduces a way of computing node motion when nodes are arranged by a FD Layout algorithm. Dynamic navigation requires that the arrangement of the nodes be constantly updated as new nodes are added to the graph and existing nodes are removed.

According to an example embodiment of the present invention, a Noise Damper may be provided that allows unimpeded motion to nodes that are moving purposefully to a new location in the graph, but slows down nodes that are oscillating around a given point or moving chaotically. Accordingly, nodes can be arranged more rapidly into stable, locally optimal positions while preventing any unnecessary or confusing motion.

### BRIEF DESCRIPTION OF THE DRAWINGS

FIG. 1 is a flowchart that illustrates an example FD Layout algorithm.

FIG. 2 is a flowchart that illustrates an example procedure of a Force-Directed layout algorithm executed in the Ghosting technique, according to an example embodiment of the invention.

FIG. 3 is a flowchart that illustrates an example procedure for animating a node addition, according to an example embodiment of the present invention.

FIG. 4 is a flowchart that illustrates an example procedure for animating a node removal, according to an example embodiment of the present invention.

FIG. 5 is a diagram that illustrates the motion of nodes during an animation of node addition or removal using the Ghosting technique, according to an example embodiment of the present invention.

FIG. 6 is a flowchart that illustrates an example procedure of a layout algorithm executed in the Noise Damper technique, according to an example embodiment of the invention.

FIG. 7 is a diagram that illustrates the derivation of the Lateral Displacement and Path Distance of a node, and the derivation of a noise value from a comparison of the two, according to an example embodiment of the present invention.

### DETAILED DESCRIPTION

The present invention can be implemented on computer hardware with a central processing unit (CPU) which can process program steps. The CPU may be connected to a memory which may store program steps for executing the Ghosting technique and the Noise Damper technique of the present invention. The memory may also store the data for the graph, the layout algorithm, and other data necessary to execute the program steps. A display may be connected to the CPU, and can display the graph. Devices, such as a mouse and a keyboard, may be connected to the CPU to allow user interaction.

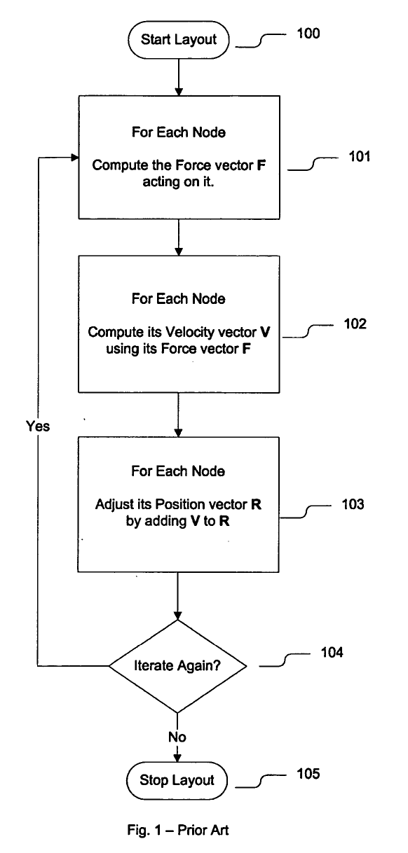

FIG. 1 illustrates an example FD Layout algorithm, according to an embodiment of the present invention. In this embodiment, the FD Layout algorithm operates on a graph which may contain nodes and edges. Nodes may have a series of associated attributes including a Position vector, a Velocity vector, and a Force vector.

At the start of the FD Layout algorithm (100), nodes may have initial values for their Position vectors and Velocity vectors. The FD Layout algorithm proceeds iteratively. At the end of each iteration, the Position vectors of the nodes may be adjusted (103). The FD Layout algorithm may continue to iterate and adjust the Position vectors of nodes as long as an iteration condition (104) is met. The iteration condition may be controlled by the user, and/or be programmatically determined. In one embodiment, the iteration condition is kept true for a set period of time, and is then set to false. In another embodiment, the iteration condition is kept true until the nodes have achieved a stable arrangement in the graph. Conventional testing methods may be applied to determine whether the layout algorithm has achieved the stable arrangement. If the iteration condition is not met, the FD Layout algorithm is stopped (105). In this embodiment, the Velocity vectors for all nodes may be set to 0 when the layout stops.

The iterative process of the FD Layout algorithm may begin with the force determination step (101). The algorithm will remain active as long as the iteration condition (104) is true.

In this embodiment, Position vectors may be calculated as the result of adding the Velocity vectors to the Position vectors from the previous iteration (103). The Velocity vectors are computed by using information about the Force vectors acting on each node (102). The Force vectors acting on the nodes may be a combination of component forces from multiple sources. For example, nodes may be affected by a node-force which treats nodes as positively charged particles which repel each other, and an edge-force which treats edges as “rubber-bands” which attract the nodes at their endpoints. Component forces may also include forces that cause a node to be attracted to specific coordinates in the position vector space. The result vectors from each of these different component forces may be combined together to form a Force vector (101).

In one embodiment, the Velocity vector (102) may be computed by adding the Force vector to the Velocity vector from the previous iteration. The magnitude of the resulting Velocity vector may then be reduced by a Friction function, decreasing its magnitude by a fixed percent or a fixed amount. A maximum limit may also be applied to reduce the magnitude of the Velocity Vector if it is too large.

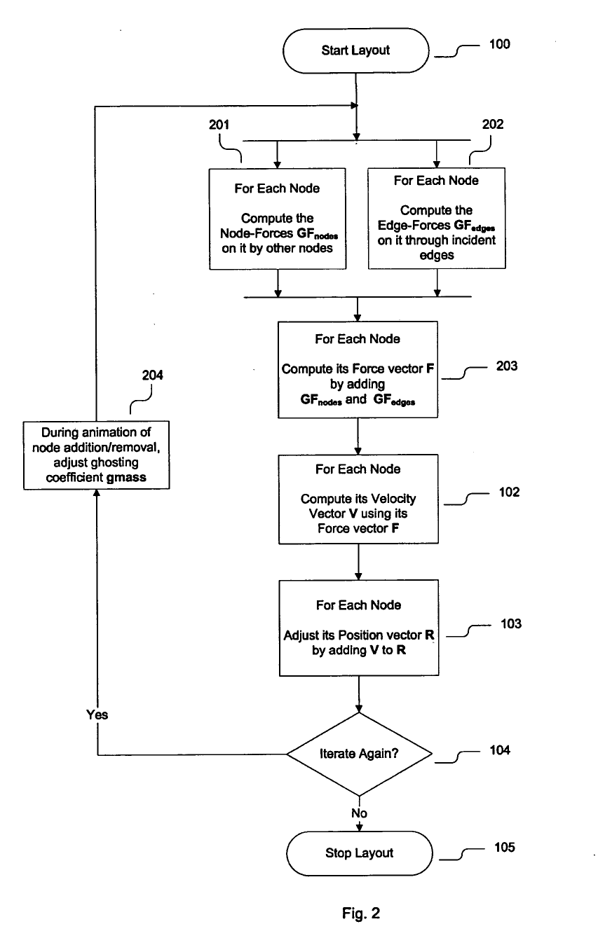

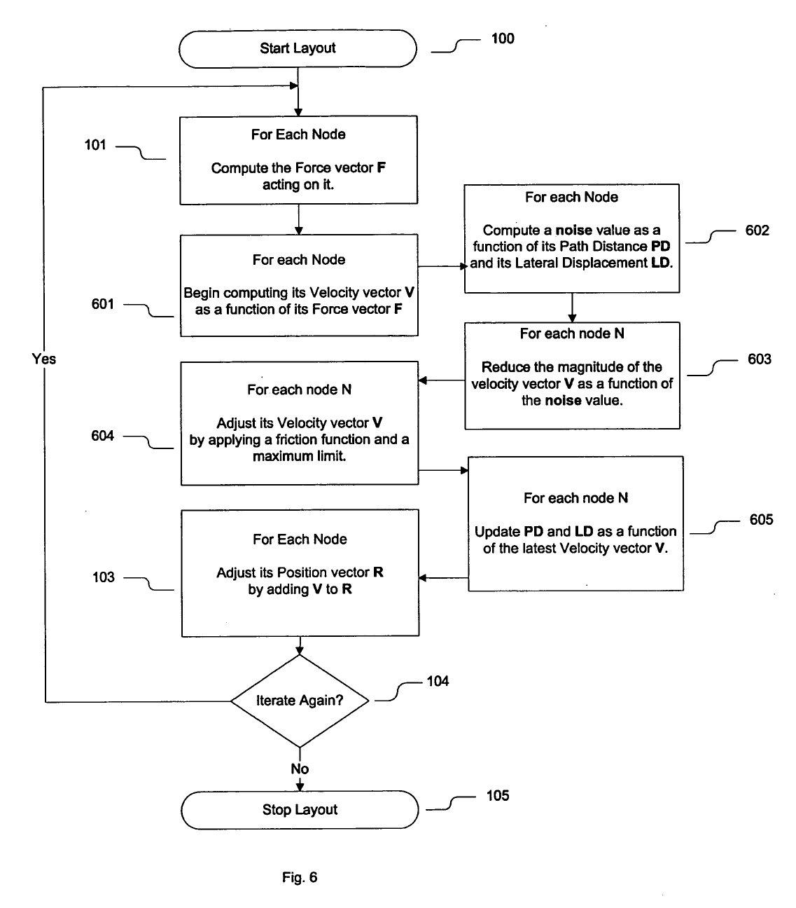

FIGS. 2 and 6 show details of the layout algorithm, according to example embodiments of the present invention which allow the layout algorithm to be used for dynamically navigating though a network. FIG. 2 shows how the forces between nodes can be adjusted to animate a node addition or a node removal. FIG. 6 shows an improved way of calculating the Velocity vector to smooth out the node motion and allow the layout to proceed faster.

Ghosting

In an example embodiment of the present invention, the FD Layout algorithm may implement a Ghosting technique for the animation of the addition and removal of nodes to and from a graph.

The Ghosting technique may be used during the process of switching the set of nodes in the graph from one set to another. Dynamic navigation and filtering of a graph may require that the set of nodes in the graph be switched from an initial set of nodes S1 to a new set of nodes S2. The switch may be performed by first removing from the graph nodes that are not in S2, referred to herein as unneeded nodes, and then adding to the graph nodes from S2 that are not yet present in the graph, referred to herein as new nodes. The Ghosting technique may be used to animate the addition of new nodes and to animate the removal of unneeded nodes from the graph. There are alternate embodiments for switching from S1 to S2 which may also use the Ghosting technique to animate node addition or removal. For example, in one alternate embodiment, the node removal and node addition steps may be reversed so that new nodes are added before unneeded ones are removed. Another embodiment may allow for either the addition or the removal to occur first depending on a setting which may be at least one of controllable by the user and automatically determined. Yet another embodiment may allow addition and removal steps to happen simultaneously.

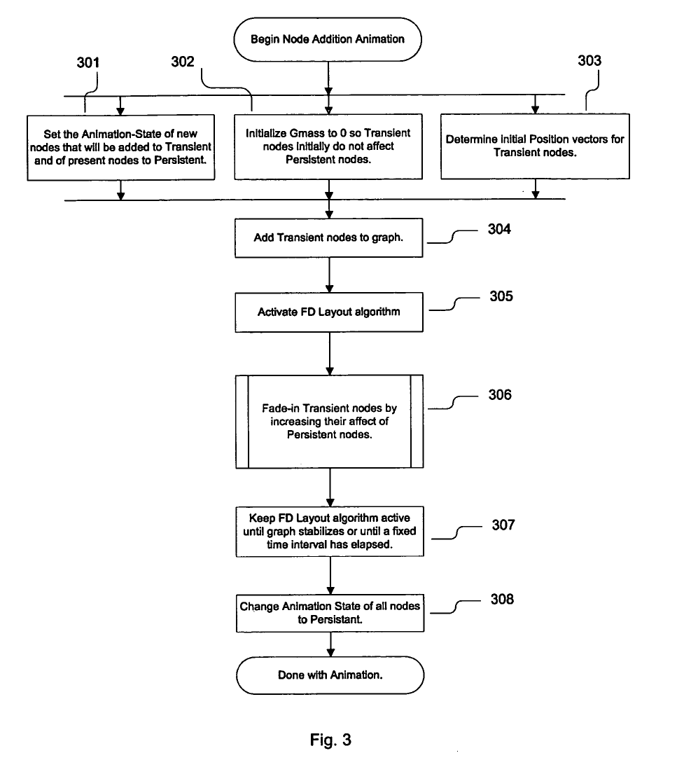

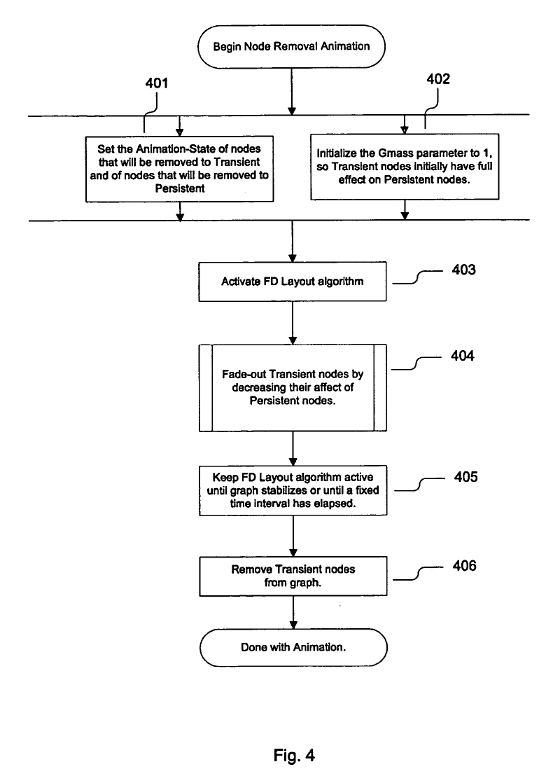

The Ghosting technique may be used to animate the addition of at least one new node to a graph containing zero or more nodes, or to animate the removal of at least one unneeded node from a graph leaving zero or more remaining nodes. The animation of the addition or removal of nodes by the Ghosting technique is referred to herein as the transition-animation. The Ghosting technique changes the component forces acting on the nodes during the animation, which affects the way they are positioned by the FD Layout algorithm. Alternate embodiments may accompany the animation with visual changes in at least one of color and transparency of nodes and edges. The use of the Ghosting technique to animate the addition of new nodes is shown in FIG. 3, and its use to animate the removal of unneeded nodes is shown in FIG. 4.

Nodes whose addition or removal is being animated are referred to herein as Transient nodes or T-nodes. Nodes that were present in the graph before the node addition animation and nodes that remain in the graph after the node removal animation are referred to herein as Persistent nodes or P-nodes. In this embodiment, nodes may have an associated attribute called animation-state which may be assigned a value of ‘Persistent’ or ‘Transient’. When the transition-animation is not in progress all nodes in the graph have a ‘Persistent’ animation state and are referred to as Persistent nodes. At the beginning of a node addition animation using the Ghosting technique, the new nodes that are about to be added to the graph have their animation-state set to ‘Transient’, and are referred to as Transient nodes or T-nodes. At the end of the node addition animation using the Ghosting technique, the T-nodes that were added to the graph have their animation state switched to ‘Persistent’ and are afterward referred to as Persistent nodes or P-nodes. At the beginning of the node removal animation using the Ghosting technique, some Persistent nodes that are designated for removal have their animation state switched to ‘Transient’ and are then referred to as Transient nodes or T-nodes. Nodes that are extant in memory but are not contained in the graph are not referred to as either Persistent nodes or Transient nodes.

FIG. 2 shows an embodiment of the FD Layout algorithm used by the Ghosting technique to adjust the positions of nodes. According to this embodiment, the FD Layout algorithm must be active for the animation to occur. FIG. 2 illustrates further details of the FD Layout algorithm described with respect to FIG. 1. The Force vector calculation step of FIG. 1 (101) has three parts as shown in further detail in FIG. 2 (201,202,203). In this embodiment, Nodes are affected by node-forces exerted on them by other nodes, and edge-forces exerted on them by incident edges and the nodes at their other endpoints. The component forces on a node by other nodes are added together to form the vector GF_{nodes} (201). The component forces on a node through incident edges are added together to form the vector GF_{edges} (202). Alternate embodiments may implement other non-node and non-edge related component forces, such as an attraction of a node to a fixed set of coordinates in the vector space of the Position vector. In this embodiment the combined node force and combined edge force on each node may be added together to form the Force vector on the node (203).

In this embodiment, the combined force of nodes GF_{nodes} on a node Nᵢ may be computed as the sum of vectors returned by a function ghostedNodeForce(Nᵢ Nₖ) for input Nᵢ and every other node Nₖ. In this embodiment, the combined force of edges on a node GF_{edges} on a node Nᵢ may be computed as the sum of a vectors returned by a function ghostedEdgeForce(E, Nᵢ, Nₖ) for input Nᵢ and every incident edge E with Nₖ as the other endpoint. The equations for GF_{nodes} and GF_{edges} are:

GF_{nodes}(Nᵢ)=Sum (ghostedNodeForce(Nᵢ, Nₖ)) for all k not equal to i

GF_{edges}(Nᵢ)=Sum (ghostedEdgeForce(E, Nᵢ, Nₖ)) for all E incident on Nᵢ with other endpoint Nₖ.

The output of the ghostedNodeForce and ghostedEdgeForce functions may be dependent on the animation-states of Nᵢ and Nₖ and on a variable parameter, referred to herein as a Gmass parameter. Gmass is described in the next paragraph. The functions ghostedNodeForce(Nᵢ, Nₖ) and ghostedEdgeForce(E, Nᵢ, Nₖ) rely on simpler functions nodeForce(Nᵢ, Nₖ) and edgeForce(E, Nᵢ, Nₖ) respectively, which are not dependent on the animation-states or on Gmass. There are many known embodiments for nodeForce and edgeForce for FD Layout algorithms. One example is that the nodeForce may repel nodes in proportion to the inverse of the square of the distance between them, and the edgeForce may attract nodes connected by an edge in proportion to the distance that the length of the edge exceeds a specified length.

During the transition-animation, Gmass may control an impact value of T-nodes on P-nodes through node-forces and edge-forces. When the transition-animation is not occurring, ghostedNodeForce(Nᵢ, Nₖ) and ghostedEdgeForce(E, Nᵢ, Nₖ) are not dependent on Gmass because all nodes are in the ‘Persistent’ animation-state. Thus, in this embodiment, the impact value of T-nodes on P-nodes only changes during the animation. The impact value of nodes through node-forces and edge-forces is referred to herein as the effect of those nodes.

In this embodiment, during the transition-animation, the node-force of a node Nᵢ on another node Nₖ is calculated as:

ghostedNodeForce(Nᵢ, Nₖ) of P-node Nᵢ on P-node Nₖ=nodeForce(Nᵢ, Nₖ)

ghostedNodeForce(Nᵢ, Nₖ) of P-node Nᵢ on T-node Nₖ=nodeForce(Nᵢ, Nₖ)

ghostedNodeForce(Nᵢ, Nₖ) of T-node Nᵢ on T-node Nₖ=nodeForce(Nᵢ, Nₖ)

ghostedNodeForce(Nᵢ, Nₖ) of T-node Nᵢ on P-node Nₖ=nodeForce(Nᵢ, Nₖ)*Gmass.

In this embodiment, the edge-force of a node Nᵢ on another node Nₖ to which it is connected by an edge E is calculated as:

ghostedEdgeForce(E, Nᵢ, Nₖ) of P-node Nᵢ on P-node Nₖ=edgeForce(E, Nᵢ, Nₖ)

ghostedEdgeForce(E, Nᵢ, Nₖ) of P-node Nᵢ on T-node Nₖ=edgeForce(E, Nᵢ, Nₖ)

ghostedEdgeForce(E, Nᵢ, Nₖ) of T-node Nᵢ on T-node Nₖ=edgeForce(E, Nᵢ, Nₖ)

ghostedEdgeForce(E, Nᵢ, Nₖ) of T-node Nᵢ on P-node Nₖ=edgeForce(E, Nᵢ, Nₖ)*Gmass.

An alternate embodiment may initially set the value of ghostedNodeForce(Nᵢ, Nₖ) and ghostedEdgeForce(E, Nᵢ, Nₖ) of T-node Nᵢ on P-node Nₖ and of T-node Nᵢ on T-node Nₖ to nodeForce(E, Nᵢ, Nₖ)*Gmass as well, with the other functions remaining as stated.

In FIG. 2, the Force vectors are calculated (203), the Velocity vectors are calculated (102) and the Position Vectors are updated (103) as described in FIG. 1. After the FD Layout algorithm completes an iteration (FIG. 1, 104), the Gmass variable may be updated (204). Gmass may be increased from a lower limit, for example 0, to an upper limit, for example 1, during the animation of node addition and decreased from an upper limit, for example 1, to a lower limit, for example 0, during the animation of node removal. Different embodiments may change the value of Gmass after every iteration, or once for every fixed number of iterations. Different embodiments may vary the amount by which Gmass is increased or decreased based on different factors. For example, Gmass may be changed by larger increments if completing an iteration of the FD Layout algorithm is taking a long time.

FIG. 3 Illustrates in greater detail how the Ghosting technique is used to animate the addition of new nodes to the graph, according to an embodiment of the present invention.

In this embodiment, several steps may be performed in preparation to adding new nodes to the graph. The Ghosting technique makes a distinction between new nodes that will be added and nodes that were previously present in the graph by assigning new nodes a ‘Transient’ animation state, and assigning previously present nodes a ‘Persistent’ animation state (301). In this embodiment, the nodes that were present in the graph at the start of the removal animation, including those that will remain in the graph, may have already been assigned a ‘Persistent’ animation state. This embodiment of the Ghosting technique may initialize the Gmass variable to 0 (302). This would cause the ghostedNodeForce and ghostedEdgeForce of T-nodes on P-nodes to be 0, which would mean that P-nodes would initially be unaffected by T-nodes. The Ghosting technique may determine the initial Position vectors that nodes will have when they are added to the graph (303). According to one embodiment, nodes that had previously been present in the graph and were then removed may retain their Position vectors from when they were last contained in the graph.

After the preparatory steps (301, 302, 303), the Ghosting technique adds the T-nodes to the graph (304). The FD Layout algorithm may now be activated if it is not already active (305). The bulk of the animation then takes place during a fade-in step (306), when the graph is rearranged by the FD Layout algorithm as P-nodes begin to be affected by T-nodes. Prior to step 306, Gmass may be initialized to 0, with the result that P-nodes are initially unaffected by T-nodes. During step 306, the Ghosting technique may progressively increase the Gmass variable towards 1 (as illustrated in 204 of FIG. 2). This would cause P-nodes to increasingly “feel” the effect of the newly added T-nodes as the ghostedNodeForce and ghostedEdgeForce of T-nodes on P-nodes approach nodeForce and edgeForce. Step 306 may end when Gmass has reached 1, which would mean that ghostedNodeForce and ghostedEdgeFore are equal to nodeForce and edgeForce for all combinations of animation states. Thus, P-nodes are affected by T-nodes to the same degree as P-nodes are by each other, and all nodes in the graph are positioned by the FD Layout algorithm as if they were P-nodes. If the FD Layout algorithm has not yet achieved a stable arrangement of the graph by the end of the fade-in step (306), different embodiments may, in the alternative, keep the transition-animation active while the FD Layout algorithm is kept active, for a fixed amount of time, or until it has achieved a stable positioning of nodes (307). The Ghosting technique may complete the animation process by changing the animation state of all nodes to ‘Persistent’ (308).

FIG. 4 Illustrates in greater detail how the Ghosting technique is used to animate the removal of unneeded nodes from the graph according to an embodiment of the present invention.

To animate the removal of nodes, the Ghosting technique may proceed in much the same way as for the addition animation, but in reverse. The Ghosting technique may make a distinction between unneeded nodes that will be removed and nodes that will remain in the graph by assigning unneeded nodes a ‘Transient’ animation state, and assigning the nodes that will remain a ‘Persistent’ animation state (401). In this embodiment, the nodes that were present in the graph at the start of the removal animation, including those that will remain in the graph, may have already been assigned a ‘Persistent’ animation state. The Ghosting technique may initialize the Gmass variable to 1 (402). This would mean that ghostedNodeForce and ghostedEdgeFore are equal to nodeForce and edgeForce for all combinations of animation-states, and that therefore nodes are initially positioned by the FD Layout algorithm as if they were all P-nodes and the transition-animation had not yet started.

The FD Layout algorithm may now be activated if it is not already active (403). The bulk of the animation then takes place during a fade-out step (404) as the Ghosting technique progressively decreases the Gmass variable towards 0, (as illustrated in 204 of FIG. 2), causing a progressive decrease in the effect of T-nodes on P-nodes. Thus P-nodes gradually move towards the positions they would assume if the T-nodes were no longer there. Step 404 may end when Gmass has reached 0, which would mean that P-nodes are no longer affected by T-nodes. In this embodiment, at the end of step 404 ghostedNodeForce and ghostedEdgeForce are equal to 0. At the end of the fade-out step (404), the P-nodes may be completely unaffected by T-nodes, and may be positioned by the FD Layout algorithm as if the T-nodes were not there. If the FD Layout algorithm has not yet achieved a stable arrangement of the graph by the end of the fade-in step (404), different embodiments may, in the alternative, keep the transition-animation active while the FD Layout algorithm is kept active, for a fixed amount of time, or until it has achieved a stable positioning of nodes (405) before moving on to the last step in the animation process (406). The T-nodes may then be removed from the graph, and the animation-transition may thereby be completed (406), leaving only the P-nodes.

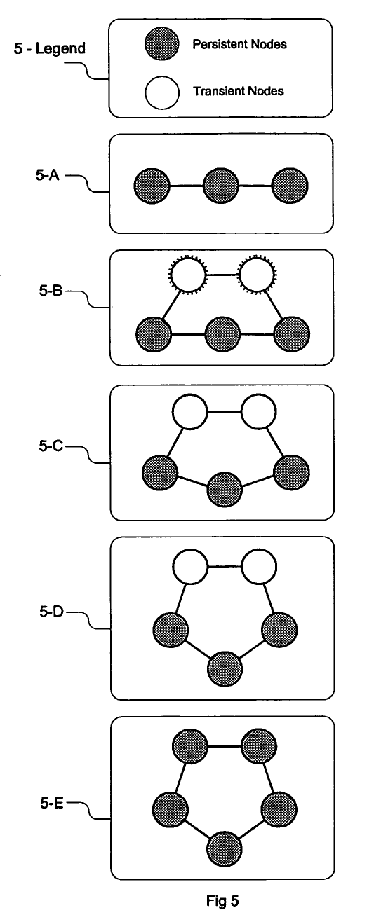

FIG. 5 illustrates how nodes may be arranged by the FD Layout algorithm during the animation of node addition by the Ghosting technique. Before the T-nodes are added, the sample graph may appear as it does in 5-A. At the beginning of the animation, this embodiment may set Gmass to 0 (as illustrated in 302 of FIG. 3), which would cause T-nodes to initially have no effect on P-nodes. Thus, the configuration of the P-nodes would initially be unchanged by the addition of T-nodes, and the nodes would be arranged for example as they are in 5-B. As the forces of T-nodes on the P-nodes increase during the fade-in step (as illustrated in 306 of FIG. 3), the P-nodes may begin to shift their configuration to accommodate the newly added T-nodes (5-C). By the end of the fade-in step (as illustrated in 306 of FIG. 3), Gmass may reach 1, in which case all nodes may be treated by the FD Layout algorithm as if they were P-nodes, although their animation states may still be different (5-D). As a last step, the animation-states of the T-Nodes may be changed to ‘Persistent’ so they become P-nodes (5-E).

FIG. 5 also illustrates how nodes are arranged by the FD Layout algorithm during the animation of node removal by the Ghosting technique. Before the T-nodes are removed, the sample graph appears as in 5-E. At the beginning of the animation, nodes whose removal is being animated may be assigned the ‘Transient’ animation state, while the remaining nodes may remain P-nodes (as illustrated in 401 of FIG. 4). At the beginning of the animation, this embodiment sets Gmass to 1 (402), which means that all nodes are effectively treated by the FD Layout algorithm as if they were P-nodes, although their animation states may still be different. The nodes may be arranged as in 5-D. As the forces of the T-nodes on the P-nodes are decreased during the fade-out step (as illustrated in 404 of FIG. 4), the P-nodes begin to be positioned as if the T-nodes were no longer there (5-C). By the end of the fade-out step (as illustrated in 404 of FIG. 4), Gmass has reached 0 and P-nodes may be positioned as if they are unaffected by T-nodes (5-B). As a last step, the T-Nodes may be removed (5-A).

Noise Damper

In an embodiment of the present invention, a technique may reduce oscillations and chaotic motion of nodes during node placement by a FD Layout algorithm. The motion of nodes may be damped by calculating a ‘noise’ value for each node. Noise values may be selectively used to decelerate nodes that are moving erratically but not those that are moving purposefully in a particular direction. The reduction in the velocity of a few chaotically moving nodes may allow the overall velocity of nodes to be increased. This may cause nodes to move more smoothly, and may allow the FD Layout algorithm to achieve a stable graph configuration more quickly. The technique of decelerating erratically-moving nodes though the calculation of a noise value is herein referred to as the Noise Damper.

According to an embodiment of the present invention, each node may have a vector attribute called Lateral Displacement, and a scalar attribute called Path Distance. The Lateral Displacement vector (referred to herein as LD) keeps track of the net displacement of a corresponding node over one or more iterations, which it may do by averaging out short term irregularities in its velocity vector. On the other hand, the Path Distance scalar (referred to herein as PD) may be a measure of the full length of the irregular path the node has traveled.

FIG. 6 illustrates an embodiment of a FD Layout algorithm containing the Noise Damper. FIG. 6 illustrates further details to the FD Layout algorithm described with respect to FIG. 1. The Velocity vector calculation step from FIG. 1 (102) is shown as steps 601 through 605. The computation of Force vectors (101), computation of Position vectors (103) and the iteration condition (104) are performed as specified in FIG. 1.

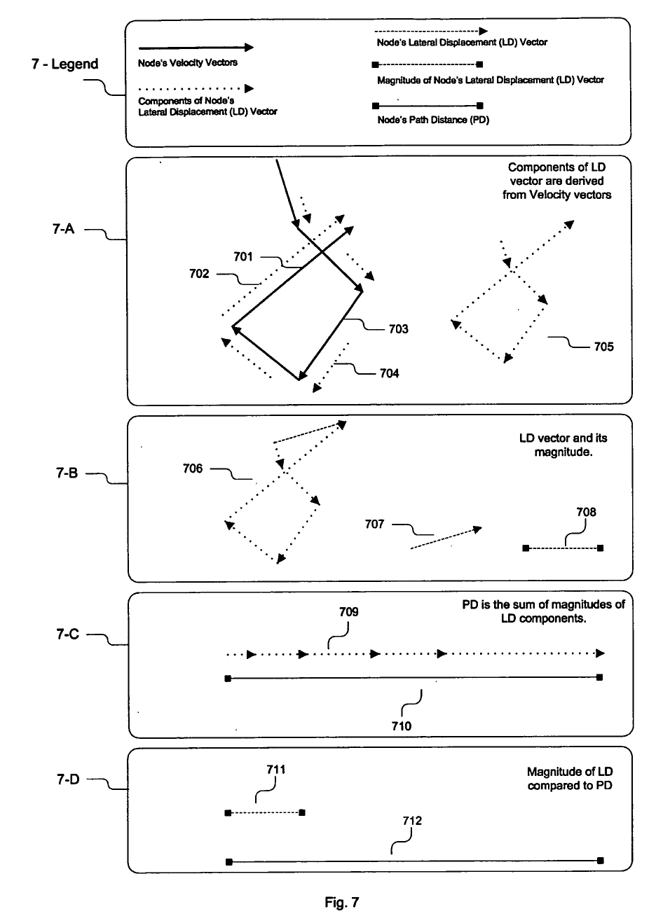

For each node, the Noise Damper may reduce the magnitude of a node's initial Velocity vector (calculated in 601) as a function of the node's noise value (602, 603). This process is further explained in the description of FIG. 7-D. The noise value may be computed as a function of the LD vector and PD scalar (602) which may be calculated from the final value of the Velocity vector (605). The computations of the LD vector and PD scalar are further described in FIG. 7 (7-A,7-B,7-C). Since LD and PD are used in 602 but updated in 605, they may be assigned default values of 0 during the first iteration. During subsequent iterations, the noise value computation (602) may use the values computed for LD and PD in step 605 of the previous iteration. Other embodiments may place the LD and PD computation step (605) after the computation of the initial Velocity vector (601) so that the initial value of the Velocity vector may be used in the computation of LD and PD.

In this embodiment of the FD Layout algorithm, the initial Velocity vector (601) is calculated by adding the Force vector from 601 to the Velocity vector from the previous iteration. Other embodiments may add the Force vector to a fraction of the Velocity vector from the previous iteration, or not add the Velocity vector from the previous iteration at all.

After the magnitude of the Velocity vector of each node is decreased by the Noise Damper technique (603), the computation of the Velocity vector may involve further steps. The present embodiment of the FD Layout algorithm may further reduce the magnitude of the Velocity vector in two ways (604). A Friction force may be applied to decrease the magnitude of the Velocity vector by a fixed percent or a fixed amount. A limit may also be imposed on the maximum magnitude for the Velocity vector, to which Velocity vectors exceeding that limit are scaled. Alternate embodiments may apply other limits and constraints to modify velocity. If a Friction function is used to decrease the Velocity, the decrease may only be a small percent because of the beneficial effects of the Noise Damper. By allowing the Friction function percent to be kept low, the Noise Damper allows the FD Layout positioning to proceed faster.

FIG. 7 illustrates, according to an embodiment of the present invention, the computation by the Noise Damper technique of the LD vector and PD scalar for each node, and how the noise value is derived from a comparison of the two.

Two possible embodiments of computing values for the LD vector and PD scalar place emphasis on the most recent movements of the node represented by its most recent Velocity vectors. Less recent Velocity vectors may either be ignored by using functions that are based only on a fixed number of the most recent Velocity vectors, or they may be given a lesser weight by using exponentially decaying functions.

In one example embodiment for computing the LD vector and PD scalar, a moving sum of the Velocity vectors may be used to compute the Lateral Displacement vector LD, and a moving sum of the magnitudes of the Velocity vectors may be used to compute the PD scalar. The moving sum is based on the k Velocity vectors from the most recent iterations. The previous ones are ignored.

In the following formulas, t is the number of the current iteration, and k is the number of iterations over which the moving sum is computed.

$${{LD}^{⟶}}_{t} := {\sum }_{i = t - k + 1}^{t} {{V}^{⟶}}_{i}$$

$${pd}_{t} := {\sum }_{i = t - k + 1}^{t} \vert {{V}^{⟶}}_{i} \vert$$

In an alternative embodiment, instead of a moving sum, an exponentially decaying sum may be used to update the LD vector and PD scalar by using their values from the previous iteration, and the Velocity vector from the current iteration. The exponentially decaying sum may give the older Velocity vectors and their magnitudes that went into computing the LD and PD from the previous iteration less weight by only using a fraction of the LD and PD vectors from the previous iteration.

In the following formulas, t is the number of the current iteration, and k is a scalar greater than 1 corresponding to the period of the exponential sum. The larger k is, the more slowly the sum will decay.
\vec{LD}ₜ:=\vec{LD}ₜ₋₁(1−1/k)+\vec{V}ₜ
pdₜ:=pdₜ₋₁(1−1/k)+|\vec{V}ₜ|

An advantage of using a decaying function to compute the LD vector and PD scalar is that their values for the current iteration may be computed from only their values from the last iteration and the current Velocity vector, thus requiring only a small amount of memory for each node. On the other hand, a sliding sum embodiment requires that Velocity vectors for the k previous iterations be stored for each node.

The formula for LD, embodied here as an exponentially decaying sum, is mathematically equivalent to:
\vec{LD}ₜ=\vec{V}ₜ+\vec{V}t−1(1−1/k)+\vec{V}ₜ₋₂(1−1/k)²+\vec{V}ₜ₋₃(1−1/k)³K

Likewise, the formula for PD embodied as an exponentially decaying sum is mathematically equivalent to:
pdₜ=|\vec{V}ₜ|+|\vec{V}ₜ₋₁|(1−1/k)+|\vec{V}ₜ₋₂|(b 1−1/k)²+|\vec{V}ₜ₋₃|(1−1/k)³K

FIG. 7, 7-A shows the correspondence between Velocity vectors from successive iterations, and the associated components of the LD vector. Velocity vectors from successive iterations Vₜ, Vₜ₋₁, Vₜ₋₂ . . . are shown as solid black arrows, the components of the LD vector, Vₜ, Vₜ₋₁(1−1/k), Vₜ₋₂(1−1/k)² . . . are shown as dotted arrows. The Velocity vector at the head (701) corresponds to the most recent Velocity vector at time t. At time t the associated Component of the LD vector has the same magnitude (702). For an earlier iteration, t−2, the Component of the LD vector (704) has decayed so its magnitude is now lower then that of the associated Velocity vector (703).

7-B shows that the LD vector (707) can be expressed as a vector sum of its components (706). In this embodiment, the components of the LD vector need not be kept in memory. The LD vector is computed using the initial exponentially decaying sum formula from the LD vector from the previous iteration and the latest Velocity vector. The magnitude of the LD Vector (708) is used in the calculation of the noise value for the node's motion.

7-C shows that the PD Scalar (710) can be computed as the sum of the magnitudes of the Components of the LD Vector (709). In this embodiment, the components of the LD vector need not be kept in memory. The PD is computed using the initial exponentially decaying sum formula from the PD scalar from the previous iteration and the latest Velocity vector.

7-D shows a comparison between the magnitude of the LD vector and the PD scalar. The two values may be used as input to a Noise function to produce a noise value which may be a scalar. For the exponentially decaying sum embodiment of LD vector and the PD scalar, it is easy to prove that the magnitude of the PD scalar will always be greater than or equal to the LD vector, since the sum of magnitudes of a set of vectors will always be greater than or equal to the magnitude of their vector sum.

The Noise Damper technique may use the PD scalar and the magnitude of the LD vector as input to a Noise function that returns a noise value which may be a scalar (602). In this embodiment, the calculated noise value may have a value of 1 or greater. It can be shown mathematically that a value of 1 indicates that the node is moving in a straight line or staying perfectly still, and a value greater than 1 indicates that the node is changing direction, and perhaps oscillating.

In one embodiment of the present invention, a Noise function may be implemented in which the PD scalar may be divided by the magnitude of the LD Vector. The Noise function may further provide the following:

if |LD|>0 then noise:=pd/|LD|

else noise=1.

If |LD| is zero, the noise value is set to 1. As discussed earlier, PD will always be greater then the magnitude of LD (|LD|), and therefore the noise value which is their quotient will also always be equal to or greater than 1.

In an alternative embodiment of the present invention, the Noise function may compute the noise value as the logarithm of the difference between PD and LD, and may provide the following:

if (|LD|>0) then noise:=Log(pd−|LD|+1)+1

else noise=1.

It can be shown mathematically that since PD will always be greater then or equal to |LD|, in the above formula the noise value will always be greater than or equal to 1.

After the noise value is calculated, this embodiment may use it to scale down the magnitude of the Velocity vector by applying a NoiseLimit function (Illustrated in 603, FIG. 6). In this embodiment, the greater the difference between the Path Distance and Linear Displacement, the greater the scalar noise value will be. Thus, a noise value of 1 means that the node is traveling in a constant direction or staying perfectly still, and higher noise values mean that the node is changing direction and perhaps oscillating. Very high noise values mean that the node is traveling over a long path (PD) without actually covering much distance (LD). In this embodiment, the NoiseLimit function decreases the magnitude of the Velocity vector simply by dividing it by the noise scalar:

V:=V/noise.

Thus, nodes that are traveling in a fairly consistent direction will be allowed to move unimpeded, while nodes that are oscillating will be slowed down in proportion to the degree of the irregularity in their movement.

Definition List 1

| Term | Definition |
|---|---|
| Force-Directed Layout | A Force-Directed Layout algorithm, also |
| Algorithm (FD Layout | referred to herein as an FD Layout algorithm, |
| Algorithm) | is an algorithm which operates on a graph |
| | where nodes have vector attributes referred |
| | to herein as Position vectors or position. |
| | The FD Layout algorithm simulates a |
| | physical system to iteratively adjust the |
| | values of the Position vectors of the nodes. |
| Velocity (velocity vector) | The vector amount by which the Position |
| | vector of a node is adjusted during an |
| | iteration is referred to herein as the Velocity |
| | vector or velocity. The calculation of the |
| | Velocity vector may take several steps. |
| Initial velocity (initial | Before the final Velocity vector is computed, |
| Velocity vector) | it may be assigned one or more preliminary |
| | values which may be referred to as the initial |
| | Velocity vector or initial velocity. |
| Component force | The computation of a Velocity vector |
| | depends on the combined result of functions |
| | referred to herein as component forces. |
| Component force on a | Each component force takes at least a first |
| node | node as a parameter, which is referred to |
| | herein as the ‘node it is acting on’ or ‘node it |
| | is on’. |
| Force vector (net force | The FD Layout algorithm combines all the |
| on a node) | component forces on a node to compute a |
| | vector referred to herein the Force |
| | vector on a node, or the net force on a node. |
| | The Force vector may be an approximation of |
| | the combined effect of the component forces if |
| | they are treated collectively during the |
| | computation. With few exceptions, the |
| | Velocity vector from the previous iteration is |
| | adjusted in the direction of the Force vector |
| | from the next iteration. |
| Impact value of a first | An impact value of a first node on a second |
| node on a second node | node, as referred to herein, is the degree of |
| | the combined effect of one or more |
| | component forces on the second node by |
| | the first node. |
| Node-set transition | A node-set transition, as referred to herein, |
| | is a process during which some nodes are |
| | removed from the graph and some nodes |
| | are added to the graph. |
| The transition-state of a | A transition-state of a node, as referred to |
| node | herein, identifies the node either as a node |
| | added to the graph, a node removed from |
| | the graph, or as a node in the graph that |
| | was neither added to nor removed from the |
| | graph. |

1. A method for animating a node-set transition from a first set of nodes to a second set of nodes in a graph arranged according to a Force-Directed Layout algorithm, the animation, comprising:
at least one of:
iteratively diminishing, in accordance with a transition-state of a first node of the graph, an impact value of the first node on a second node of the graph; and
iteratively increasing, in accordance with a transition-state of a third node of the graph, an impact value of the third node on the second node.

2. The method of claim 1, wherein during the increase, the impact value of the third node is initially 0, and during the diminishment, the impact value of the first node is reduced to 0.

3. The method of claim 1, wherein:
the impact value of the first node on the second node is diminished one of (a) upon a condition that the first node is removed from the graph during the transition and the second node is not removed from the graph during the transition, and (b) upon a condition that the first node is removed from the graph during the transition, even if the second node is removed from the graph during the transition; and
the impact value of the third node on the second node is increased one of (a) upon a condition that the third node is added to the graph during the transition and the second node is not added to the graph during the transition, and (b) upon a condition that the third node is added to the graph during the transition, even if the second node is added to the graph during the transition.

4. The method of claim 3, wherein:
a first amount by which the impact value is increased during an iteration and a second amount by which the impact value is decreased during the iteration are adjustable; and
the first and second amounts are determined by factors including a length of time to complete the iteration.

5. The method of claim 1, wherein coordinates of nodes that are removed from the graph are retained in memory.

6. The method of claim 5, wherein during an addition to the graph of a previously-removed node, the previously-removed node is initially placed in its previous location in the graph.

7. The method of claim 1, wherein the animation is visually represented by changes in at least one of color and transparency.

8. A method of setting a velocity of a node of a graph, the graph arranged according to a Force-Directed Layout algorithm, comprising:
reducing the velocity from an initial value in proportion to a degree of the node's non-directional movement.

9. The method of claim 8, wherein the reduction of the velocity includes:
calculating a measure of a length of a path traveled by the node over at least one iteration as a path distance;
calculating a lateral displacement of the node over the at least one iteration;
calculating a noise value based on a comparison of the path distance to a magnitude of the lateral displacement; and
reducing the velocity of the node based on the noise value.

10. The method of claim 9, wherein:
each of the lateral displacement and the path distance for the node is calculated as a function of a time series of the node's velocity vectors from successive iterations;
the lateral displacement is calculated based on a smoothing function of the velocity vectors; and
the path distance is calculated based on a smoothing function of the magnitudes of the velocity vectors.

11. The method of claim 10, wherein, for each of the lateral displacement calculation and the path distance calculation, less weight is given to a velocity vector of a first iteration than to a velocity vector of a second iteration that is more recent than the first iteration.

12. The method of claim 10, wherein:
the lateral displacement is calculated according to one of a moving average, a weighed moving average, a moving sum, a weighed moving sum, an exponential moving average, and an exponential moving sum; and
the path distance is calculated according to one of a moving average, a weighed moving average, a moving sum, a weighed moving sum, an exponential moving average, and an exponential moving sum.

13. The method of claim 10, wherein:
a lateral displacement for a current iteration is calculated based on a combination of a stored value of a lateral displacement of an immediately preceding iteration and the velocity vector of the current iteration;
the path distance for the current iteration is calculated based on a combination of a stored value of a path distance of the immediately preceding iteration and the velocity vector of the current iteration.

14. The method of claim 9, wherein the noise value is calculated based on one of (a) a ratio of the path distance to the magnitude of the lateral displacement and (b) a difference between the path distance and the magnitude of the lateral displacement.

15. The method of claim 8, wherein the reduction is ceased in response to at least one of (a) a user interaction, and (b) a programmatically determined setting.

16. An article of manufacture comprising a computer-readable medium having stored thereon instructions adapted to be executed by a processor, the instructions which, when executed, define a method for animating a node-set transition from a first set of nodes to a second set of nodes in a graph arranged according to a Force-Directed Layout algorithm (FDLA), the method comprising:
at least one of:
iteratively diminishing, in accordance with a transition-state of a first node of the graph, an impact value of the first node on a second node of the graph; and
iteratively increasing, in accordance with a transition-state of a third node of the graph, an impact value of the third node on the second node.
